(19) United States
(12) Patent Application Publication
(10) Pub. No.: US 2015/0065078 A1
(43) Pub. Date: Mar. 5, 2015

(54) ALARM SYSTEM

(71) Applicants: Leonardo Mejia, Harleysville, PA (US); Finina Mejia, Harleysville, PA (US); Lucas Mejia, Harleysville, PA (US); Abigail Mejis, Harleysville, PA (US)

(72) Inventors: Leonardo Mejia, Harleysville, PA (US); Finina Mejia, Harleysville, PA (US); Lucas Mejia, Harleysville, PA (US); Abigail Mejis, Harleysville, PA (US)

(21) Appl. No.: 14/395,144

(22) PCT Filed: Apr. 26, 2013
(86) PCT No.: PCT/US2013/038362

§ 371 Date: Oct. 17, 2014

Related U.S. Application Data
(60) Provisional application No. 61/687,536, filed on Apr. 27, 2012.
(60) Provisional application No. 61/688,406, filed on May 14, 2012.
(60) Provisional application No. 61/689,141, filed on May 31, 2012.
(60) Provisional application No. 61/689,671, filed on Jun. 11, 2012.

(51) Int. Cl. H04M 11/04; G08B 17/00; G08B 25/01

(52) U.S. Cl. CPC H04M 11/04; G08B 25/016; G08B 17/00
USPC 455/404.1

(57) ABSTRACT

A fire alarm system utilizes a wireless transmitter associated with each of a plurality of smoke detectors to provide the occupant of a building with an early warning through the wireless receiver in the occupant's smart phone. The wireless signal includes encoded information identifying the activated smoke detector, and the smart phone app uses this information to guide the user safely out of the building. Where the building has multiple exits, the smart phone app can use information on the current location of the smart phone, determined by a local location system, together with the smoke detector identification to inform the user of a preferred escape route.

### CROSS-REFERENCE TO RELATED APPLICATIONS

This application claims the benefit of the following U.S. Provisional Patent Applications: 61/687,536, filed Apr. 27, 2012, 61/688,406, filed May 14, 2012, 61/689,141, filed May 31, 2012, and 61/689,671, filed Jun. 11, 2012.

### FIELD OF THE INVENTION

This invention relates to alarm systems, and more particularly to a system for providing to occupants of a building an early warning of a hazardous condition, particularly a fire, smoke, or harmful gas such as carbon monoxide.

### BACKGROUND OF THE INVENTION

A typical house used as a residence is equipped with several smoke detectors. Most residential smoke detectors are self-contained, battery-powered, devices that utilize either a source of light and a photodetector, or a radioactive source and an ionization chamber. Interference to the light beam, or a change in the level of ionization, caused by the presence of smoke particles is detected electrically, and an audible alarm signal is generated.

These self-contained smoke detectors are typically installed in or near a bedroom, and, in the case of a fire at a remote location in the home, may be activated only after the fire has reached a level of involvement such that it is too late to attempt to extinguish it with a handheld fire extinguisher, and the only practical step is to evacuate the home. In some cases, evacuation paths are already blocked by smoke or flames, and the residents' only recourse is to exit through a window, which, of course presents its own hazards, especially if the window is on an upper floor, or if a resident is physically disabled.

Even if one of the self-contained alarms is installed near the location of the fire, the alarm that it sounds may not be heard in a remote bedroom. For example, if a fire breaks out in the kitchen of a home in the middle of the night, and the smoke alarm in the kitchen is activated, a resident in a bedroom of the house may not hear the alarm either because he or she is playing music while asleep, or because the bedroom door is shut. The individual will only be alerted to the fire when the smoke reaches a smoke alarm in or near the bedroom. By that time, most of the house may be filled with smoke, and the residents may be trapped and overcome by smoke inhalation.

The problem of delayed warning discussed above can be addressed by using a central alarm system that has multiple smoke detectors placed strategically within the home, and multiple alarm emitting devices, arranged so that when smoke is detected by any of the detectors, all of the alarm emitting devices are activated. These central alarm systems are superior to self-contained detector alarms, but most of them still have the drawback that they do not inform the residents of the location of the fire. Moreover, central alarm systems tend to be much more expensive than self-contained smoke detector alarms, and, for many, the high cost of the central alarm systems compared to that of a few self-contained smoke detector alarms is a deterrent to the use of the central alarm and an inducement to use self-contained smoke detectors instead.

Another problem arises in larger buildings such as apartment buildings, hotels, office buildings and the like. Such buildings are normally equipped with a central alarm, and occupants are directed, either by signs or automated voice warnings, to evacuate using stairwells rather than elevators. However, in the case of a building having plural stairwells, the occupants may not know the location of the fire and are therefore not necessarily made award of the optimum exit route. Moreover, some occupants may not be familiar with the building or with the directions of its hallways. Thus, if directed to “use the west stairwell,” for example, some persons may become confused and lose precious time in their effort to evacuate.

There is a need, therefore, for an improved smoke detecting alarm system that provides as early as possible a warning of the existence of a fire in a house or other building. There is also a need for an improved smoke alarm system that can provide alert the occupant of a remote fire using conventional self-contained, battery-powered smoke detectors without modification. There is also a need for a smoke detecting alarm that provides each occupant of a building with exit route information based on the location of the fire. Finally, is a need for a smoke detecting alarm that provides each occupant of a building with individualized exit route information based on that occupant's location.

Background prior art is found in U.S. Pat. No. 4,160,246, granted Jul. 3, 1979, U.S. Pat. No. 6,420,973, granted Jul. 16, 2002, and U.S. Pat. No. 7,403,838, granted Jul. 22, 2008.

### SUMMARY OF THE INVENTION

The invention is an early warning system designed to alert occupants of a house or other building of a hazardous condition, such as a fire as soon as possible after the hazardous condition has been detected by a detection device such as a smoke detector. Each of one or more detection devices in the building is associated in close proximity with a wireless transmitter which is arranged to be triggered by the detection device. When triggered, the wireless transmitter emits a radio signal that is received by one or more receiver units causing each receiver unit to emit an alarm. The receiver units can be smart phones each having a wireless receiver and an installed application that causes the smart phone to emit an alarm in response to the radio signal. Instead of a smart phone, a dedicated receiver can be used.

Even if the detection device is located in a remote part of the building, a user in close proximity to the receiver unit will be alerted immediately to the hazard and can take immediate steps to alert other occupants, evacuate the building, and notify firefighters and other emergency responders. Optionally, the system can include an additional receiver unit that automatically makes an emergency call.

If the wireless transmitters of the system of the invention are equipped with microphones and filters for distinguishing alarm sounds from other sounds, the system of the invention can utilize conventional smoke detectors, and can be implemented in a building in which smoke detectors are already installed, without modifying the existing smoke detectors. Alternatively, self-contained detector/transmitter units can be provided, each incorporating a detection device and a wireless transmitter.

The smart phone application can be used in conjunction with an indoor location system. For example, if the smart phone has a global positioning (GPS) capability, using a system of local transmitters that generate signals corresponding to the signals emitted by positioning satellites, the smart phone application can determine the user's position, and where the user has a choice of escape routes from a hotel or apartment building, the application can automatically direct the user to an exit along a safe escape route.

In its more general aspects, the alarm system in accordance with the invention comprises a detector, a wireless local area network (LAN) transmitter, and one or more smart phones, each having a wireless receiving capability, i.e. a “WiFi” mode or similar mode compatible with the signal transmitted by the wireless LAN transmitter. The detector, which can incorporate a conventional smoke detection device such as the optical or ionization-type smoke detectors mentioned above, produces, in addition to, or as an alternative to, a local audible alarm, an electrical signal in response to the presence of smoke or another detected hazardous condition. The wireless LAN transmitter is associated with the detector and responds to the electrical signal produced by the detector by producing a radio signal indicative of the hazardous condition. Each smart phone in the system has a stored smart phone application, which, when activated by the radio signal transmitted over the wireless LAN, causes the smart phone to generate an alarm in response to the radio signal.

In a second aspect of the invention, the wireless local area network transmitter can be a part of a wireless access point.

In a third aspect of the invention, the smart phone application can include means for automatically turning on the wireless receiver in the smart phone when said smart phone application is activated.

In a fourth aspect of the invention, the alarm generated by the smart phone includes both visual and audible elements. For example, the smart phone will issue a distinctive sound such as a siren noise, or a synthesized or recorded voice message, as well as a visible signal such as repeated flashing of the phone's display screen, or flashing of a light emitting diode (LED) incorporated into the phone, such as an LED used to illuminate a subject when the smart phone's camera is operated in a dark or dimly lit environment.

In a fifth aspect of the invention, in the radio signal indicative of the hazardous condition, the wireless LAN transmitter also transmits data the location of the activated detector that produced the electrical signal in response to the hazardous condition. In accordance with a sixth aspect of the invention, the smart phone application can include means responsive to the location data for displaying information the location of the activated detector.

In a seventh aspect of the invention, useful especially where the transmitter is in close proximity to one or more detectors, the wireless LAN transmitter can include means for transmitting data the location of the transmitter in the radio signal indicative of the hazardous condition.

Then, in accordance with an eighth aspect of the invention, the smart phone application can include means responsive to said data for displaying information the location of said transmitter.

In accordance with a ninth aspect of the invention, the wireless local area network transmitter can include means for transmitting, in the radio signal indicative of the hazardous condition, data the location of the activated detector, and also the location of at least one fire exit through which a user of a smart phone can escape without passing into dangerous proximity to the activated detector.

In accordance with a tenth aspect of the invention, the wireless local area network transmitter can include means for transmitting, in the radio signal indicative of the hazardous condition, data the location of at least one fire exit through which a user of the smart phone can escape without passing into dangerous proximity to the activated detector, and the smart phone application can include means, responsive to the data the location of at least one fire exit, for displaying information describing the location of said at least one fire exit.

In accordance with an eleventh aspect of the invention, the detector can include a smoke detector, a transducer responsive to the smoke detector for emitting an audible sound at a predetermined frequency, a microphone producing an output, a frequency-selective filter connected to the output of the microphone for passing microphone output at said predetermined frequency while attenuating microphone output at frequencies other than said predetermined frequency. The electrical signal is derived from the microphone output passed by the filter.

According to a twelfth aspect of the invention, wherein the detector includes the above-mentioned microphone and filter, the transmitter can include a timer and means responsive to the timer and to the microphone output passed by the frequency-selective filter for causing the wireless local area network transmitter to produce said radio signal indicative of said hazardous condition only when the duration of the microphone output passed by the frequency-selective filter in response to said audible sound exceeds a predetermined limit.

In accordance with a thirteenth aspect of the invention, the wireless local area network transmitter includes means for transmitting, in said radio signal indicative of said hazardous condition, data the location of at least one fire exit through which a user of the smart phone can escape without passing into dangerous proximity to the detector, and in which the smart phone application includes means responsive to said data for displaying a an escape route to said at least one fire exit.

In accordance with a fourteenth aspect of the invention, the wireless local area network transmitter includes means for transmitting, in the radio signal indicative of the hazardous condition, data the locations of plural fire exits, and in which the smart phone application includes means for determining the position of the smart phone in relation to the detector, and means responsive to the position-determining means for selecting one of the plural fire exits, through which the user of the smart phone can escape without passing into dangerous proximity to the detector, and for displaying an escape route from the present location of the smart phone to the selected fire exit.

Other aspects, features and advantages of the invention will be apparent from the following detailed description when read in conjunction with the drawings.

### BRIEF DESCRIPTION OF THE DRAWINGS

FIG. 1 is a block diagram of an alarm system according to the invention, composed of a smoke detector, a wireless local area network transmitter, and plural smart phones;

FIG. 2 is a block diagram illustrating the operation of the alarm system of FIG. 1;

FIG. 3 is a flow diagram illustrating the operation of the alarm system of FIGS. 1 and 2;

FIG. 4 is a block diagram of an alternative embodiment of the alarm system;

FIG. 5 is a combination block diagram and flow diagram illustrating the layout and operation of an alarm system according to the invention in a multi-occupant building; and

FIG. 6 is a flow diagram showing the operation of the smart phone application used in the alarm system according to the invention.

### DETAILED DESCRIPTION OF THE PREFERRED EMBODIMENTS

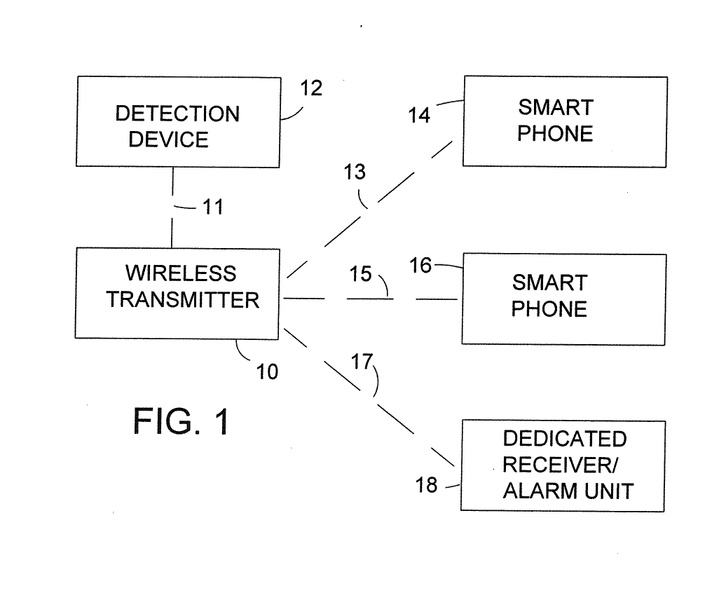

In its simplest form, the system of the invention comprises a detection unit, e.g., a smoke detector, a wireless transmitter associated with the detection unit, and a receiver responsive to the signal emitted by the wireless transmitter and incorporating an alarm device for alerting an individual in close proximity to the receiver. In a typical system, as shown in FIG. 1, a wireless transmitter 10 is in sufficiently close proximity to a detection device 12, e.g., a conventional smoke detector, that it can be activated by the alarm sound emitted by the detection device and transmitted to the detection device through the air over path 11. Activation by sound can be accomplished easily and reliably if the wireless transmitter is located in the same room, and not more than about 30 meters from the detection device.

The wireless transmitter is preferably a wireless local area network (WLAN) transmitting device operating under a suitable wireless standard such as IEEE 802.11, and can be implemented by any of many commonly available wireless gateway or router devices. Almost any such device will have a sufficient range to communicate with a wireless receiver/alarm unit in a single detached dwelling regardless of the relative positions of the transmitter and receiver/alarm unit. In larger buildings, higher power transmitters, special antennas, repeaters, boosters, or redundant transmitter units, can be utilized to ensure reliable coverage.

The transmitted alarm signal is encoded so that the receiver/alarm unit can distinguish an alarm signal from other radio signals.

As shown in FIG. 1, the wireless transmitter is activated acoustically by the detection unit 12, but transmits a radio signal to one or more receiver/alarm units. Each of the receiver/alarm units 14 and 16 can be a smart phone such as an Apple iPhone handheld mobile telephone, a DROID mobile telephone, available from various manufacturers, or one of the Samsung GALAXY series of mobile telephones, provided that the smart phone has the capability of receiving locally generated wireless signals, and of utilizing an installed application to generate an audible and, optionally a visible, alarm in response upon reception of a wireless alarm signal. Alternatively, instead of a smart phone, one or more of the receiver/alarm units can be dedicated units, each having a receiver capable of distinguishing an encoded alarm signal from other radio signals, and an alarm device for alerting an individual by an audible, and optionally a visible, alarm when the encoded alarm signal is received.

At least one additional receiver/alarm unit can be a dedicated unit 18, utilized to communicate by telephone with emergency services, e.g., directly with a local fire station, or through an emergency system, e.g., the “911” or “112” emergency systems. The additional receiver/alarm unit can also be a wireless access point, in which case, if the unit is connected to the internet, it can transmit a digital message to emergency services if the emergency services are equipped to receive such digital message. Depending on the information contained in the signal transmitted by the wireless transmitter 10, the wireless access point can also transmit digital messages to any designated recipient using the internet.

The smart phones and dedicated receiver/alarm unit receives signals transmitted by transmitter 10 over wireless paths 13, 15 and 17.

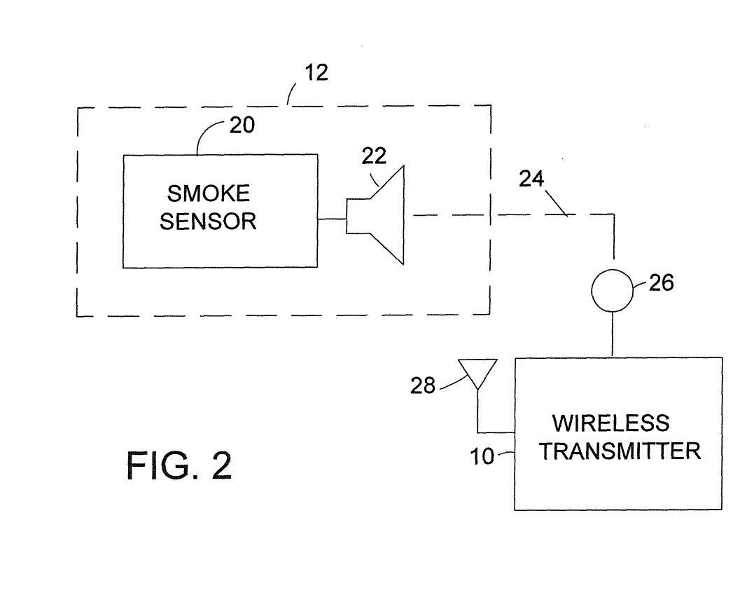

As shown in FIG. 2, the detection device 12 comprises a smoke detector 20, which can be an suitable device capable of responding to the presence of smoke, such as an optical or ionization-type smoke detector. The detector generates an electrical signal that activates an acoustic transducer 22, such as a piezoelectric “speaker”. A typical piezoelectric speaker in a smoke detector emits high intensity sound the main component of which is an oscillation at a frequency of 3.2 KHz.

The sound emitted by the acoustic transducer 22 of detection device 12 travel over path 24 to a microphone 26 associated with the wireless transmitter unit 10. The microphone produces an electrical output that activates the transmitter, causing the transmitter to generate a radio signal, which is transmitted by antenna 28. In the case of a building having multiple detection devices, each associated with its own wireless transmitter, the outputs of the several transmitters should be encoded with identifying information that enables the receiver to identify the particular wireless transmitter and thereby inform the user of the receiver of the approximate location of the fire or other hazardous condition. Because the transmitter unit 10 is coupled to the detection device acoustically, the transmitter unit should incorporate a filter to distinguish the alarm sound generated by the detection unit from extraneous noises. The filter preferably incorporates not only a frequency selective device or network, but a timer. The frequency selective device can be an L-C resonant circuit, a frequency selective network, an active filter, a digital filter, a mechanical filter, e.g., a piezoelectric device, or any of various kinds of frequency-responsive devices capable of distinguishing a frequency such as the typical 3.2 KHz frequency emitted by a piezoelectric speaker from other frequencies outside its passband. The timer assists the frequency selective device in distinguishing the audible alarm from other sounds by ensuring that the wireless transmitter's encoded output signal is activated only if the audible alarm is sounded at least over a predetermined interval. This interval can be short, e.g., a few seconds, or even a fraction of a second. However, to avoid false alarms, this interval should be longer than the interval of the low battery warning “beep” issued by the smoke detector.

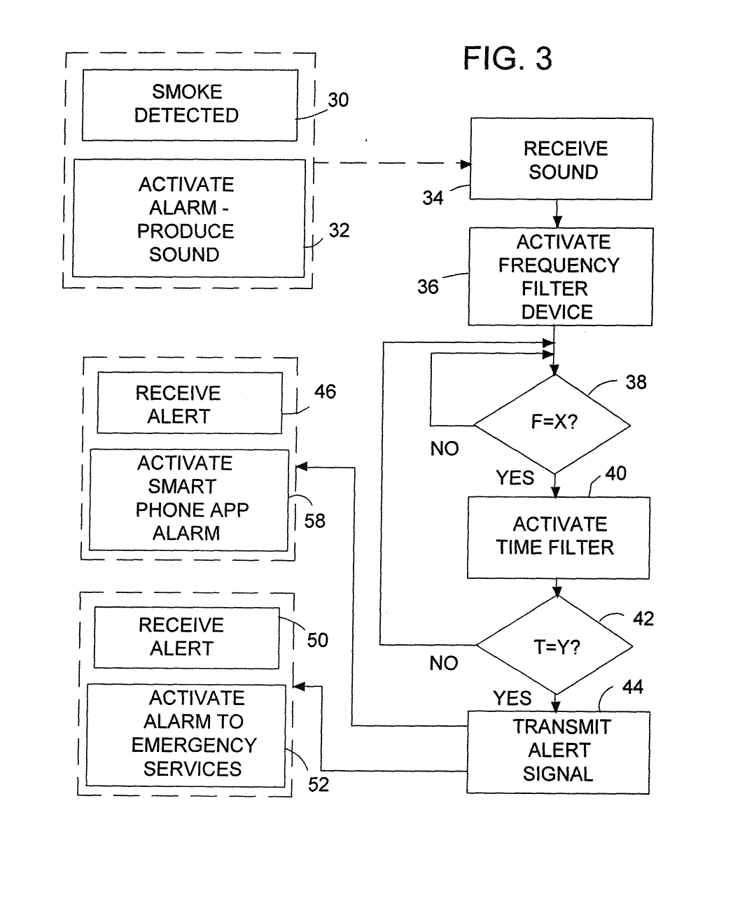

As shown by way of a flow chart in FIG. 3, when smoke is detected at step 30, the detection device emits an acoustic signal at step 32. This signal is a continuous, high-pitch oscillation, typically at a frequency of 3.2 KHz. The alarm sound continues until smoke is no longer present in the detection device, or the operating power for the detection device is cut off, e.g., due to battery failure. The acoustic signal is received at 34, converted by the microphone to an alternating electrical signal, at the same frequency as that of the acoustic oscillation, and fed to the frequency selective device at step 36. At 38, a logical determination is made concerning whether or not the amplitude of the output of the frequency selective device is above or below a first predetermined threshold. As long as the amplitude is below the threshold no action is taken. If the amplitude of the output of the frequency selective device exceeds the first predetermined threshold, then the process proceeds to step 40, in which the timer is activated. At step 42, a determination is made concerning whether or not the amplitude falls below a second threshold before the end of the predetermined interval set by the timer. The second threshold is preferably either the same as, or lower than, the first threshold. If the amplitude drops below the second threshold, the process proceeds from step 42 back to step 38 and awaits another occasion when the amplitude rises above the first threshold. On the other hand, if the amplitude remains above the second threshold throughout the predetermined interval set by the timer, the process proceeds to step 44, and the wireless transmission of an alarm signal is initiated.

The filter process can be implemented by a combination of any of the frequency selective devices mentioned above with circuitry for establishing an amplitude threshold or thresholds, and a predetermined time interval, and suitable logic elements. A circuit composed of discrete elements such as counters, operational amplifiers, and the like can be utilized. Alternatively, programmable logic controllers (PLCs) or similar devices can be used.

As shown in FIG. 3, when the activation of the wireless transmitter takes place, an encoded signal is transmitted. This encoded signal is received by each smart phone, within the range of the transmitter, that has been enabled to respond to the signal. Upon reception of the signal at step 46, an alarm application resident in the smart phone activates an alarm, which can be an audible alarm, a vibration, a visual alarm such as flashing of the display screen or flashing of an LED used with the smart phone's camera, or any combination of such alarms. A dedicate receiver, i.e., a receiver that is not a smart phone, can also be utilized to generate an alarm in response to the encoded transmitted signal.

In addition, the encoded transmitted signal can be received at step 50 by a dedicated wireless receiver unit, which, upon receipt of the encoded signal, automatically sends an alarm message, at step 52, to emergency services, and optionally to the user's security service. This alarm message will notify the recipient of the emergency and its location.

The smart phone application enables the smart phone to emit a distinctive alarm upon receipt of a particular encoded signal through its wireless receiver. In many smart phones, the wireless receiver is normally deactivated to prolong battery life. The smart phone app can be programmed so that it automatically activates the smart phone's wireless receiver when the smart phone emergency alarm application is activated. The smart phone can also be programmed to activate both the wireless receiver and the emergency alarm application at a predetermined time, e.g., the user's usual bed time, and to deactivate the wireless receiver and the application at a selected time in the morning.

Where a house or other building is equipped with plural wireless transmitters, each associated with a different detection device, each of the transmitters should be arranged to transmit a different code so that a smart phone application can distinguish the transmitter codes from one another and thereby identify to the user the particular transmitter that was activated. The smart phone application can cause the smart phone to identification the location of the fire or other hazardous condition through a screen display, e.g., a message reading “FIRE IN GARAGE”, or through similar information in the form of a pre-recorded or synthesized voice message.

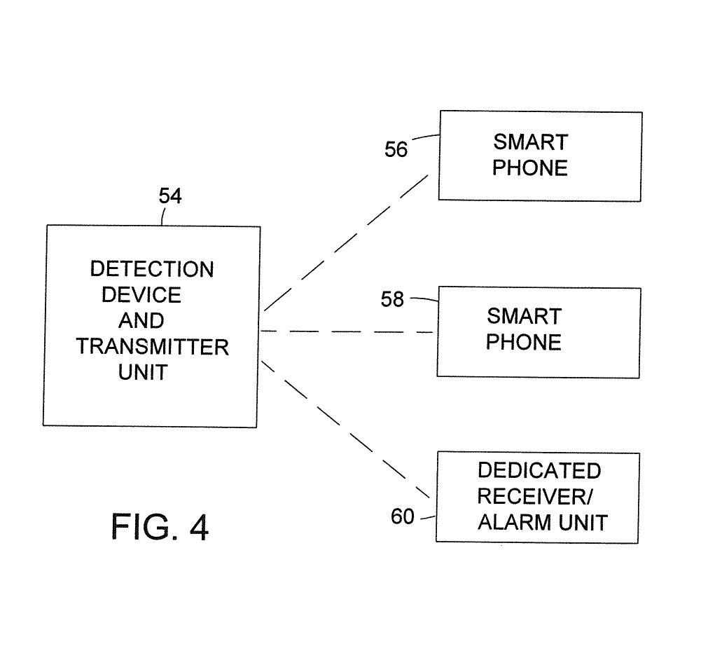

In an alternative embodiment illustrate in FIG. 4, the detection device and wireless transmitter can be hard-wired together, forming a device 54, which can be supplied as a unit. A user can purchase one or more such units, place them at suitable locations in the a house or other building, and use them with one or more smart phones such as smart phones 56 and 58, and with a dedicated receiver 60, corresponding to unit 18 in FIG. 1, and having an emergency calling capability.

In a modified version of the alarm system of FIG. 4, each smoke detector can be associated with its corresponding transmitter through a cable, which can be of any desired length. In this way, the transmitters can be positioned for optimum area coverage. If a detector is at a large distance from its associated transmitter, the hazard location information supplied to the user through the user's smart phone should identify the location of the detector rather than the location of the transmitter.

In still another modification of the system of FIG. 4, each transmitter can be associated with plural smoke detectors through cables. In this modification, the transmitter should be capable of transmitting a unique code identifying the location each activated detection device with which it is associated.

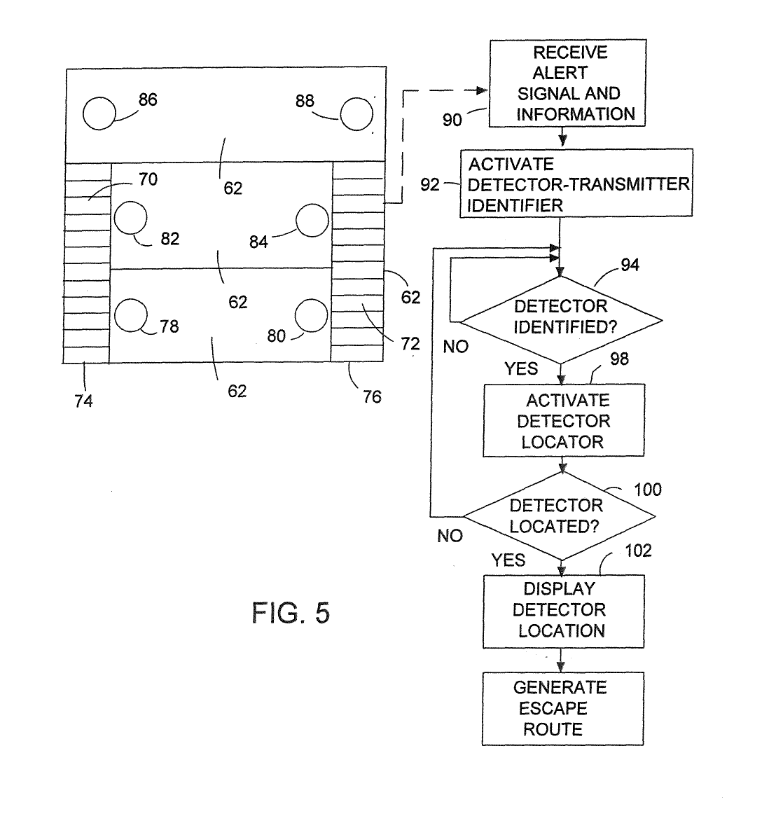

In a building having multiple exits, and especially a multi-story building having numerous smoke detectors, it is useful for the alarm system to be capable of informing each user of an alarm-capable smart phone in the building of the location of the fire or other hazard and the most appropriate escape route. FIG. 5 illustrates one version of such an alarm system.

Building 62, shown schematically in FIG. 5, is a three-story building having first, second and third floor hallways 64, 66, and 68, stairwells 70 and 72 opening at the opposite ends of each hallway, exits 74 and 76 at the bottoms of the respective stairwells. Detection devices are provided adjacent both ends of each hallway. Thus, the first story hallway has detection device 78 adjacent stairwell 70, and detection device 80 adjacent stairwell 72. Similarly, detection devices 82 and 84 are located in the second story hallway 66 adjacent stairwells 70 and 72 respectively, and detection devices 86 and 88 are located in the third story hallway 68 adjacent stairwells 70 and 72 respectively. Each of these detection devices 78-88 is preferably hard-wired, rather than acoustically coupled, to an associated wireless transmitter.

As shown by the flow diagram portion of FIG. 5, if a wireless signal indicating that any of the detectors has been activated by smoke or another hazardous condition, a unique identification code is transmitted in the wireless signal. When the signal is received by an occupant's smart phone at step 90, the code identifying the activated detection device is read in step 92, and a determination is made in step 94 that the code either corresponds to a detection device in the building or does not correspond to any detection device in the building. If the code is recognized, it identifies the location of the activated detection device at step 96 when it is read by the smart phone application. If the location of the detector is determined, then at step 98, the smart phone application proceeds to display information concerning the detector location at step 100, and, if the application is equipped to do so, an escape route is generated at step 102.

In the simple example shown in FIG. 5, it will be sufficient that the information concerning the location of fire or other hazard that is identified on each occupant's smart phone simply provide the location in terms of the end of the building in which the activated detection device is situated. Thus, the visually displayed or audible information can be simply “FIRE DETECTED NEAR WEST STAIRWELL.” This information can be contained in the encoded alarm signal transmitted by the wireless transmitter, or incorporated into the stored application in each smart phone and triggered by the encoded signal. The message can also include a recommended exit route, e.g., “FIRE DETECTED NEAR WEST STAIRWELL. PLEASE EXIT THE BUILDING USING EAST STAIRWELL.”

In a more advanced version, the information can also identify the floor on which the activated detection device is located. For example, the message displayed or announced by the smart phone could be, “FIRE DETECTED ON FIRST FLOOR NEAR WEST STAIRWELL. PLEASE EXIT THE BUILDING USING EAST STAIRWELL.”

A still more advanced version is especially suited for larger buildings having multiple detection devices distributed along the lengths of hallways. If a fire occurs at an intermediate location in or along a hallway on a given floor it may become necessary for some occupants of that floor to exit using one stairwell, and for other occupants of the same floor to exit using a different stairwell. In such a case, the smart phone application can be designed to determine the user's location in relation to the activated detection device, and to direct the user to the appropriate stairwell using a path that does not require the user to pass into dangerous proximity to the activated detector. Thus, by following the direction given by the smart phone, the user can escape while staying far away from the location of the fire.

Although most smart phones have a global positioning system (GPS) receiver capable of locating a smart phone with relatively high accuracy, GPS receivers do not work well inside buildings because the building structures shield the signals transmitted by overhead positioning satellites. However, smart phones having GPS capability can be located indoors by the use of “pseudo satellite” transmitting units as described in United States Patent Application Publication 2013/0093619, published Apr. 18, 2013. Smart phones can also be located indoors by calculations based on signal strength measurements as described in United States Patent Application Publication 2012/0322501, published Dec. 20, 2012, and by sensing vibrations acoustically using microphone arrays as described in United States Patent Application Publication 2013/0053053, published Feb. 28, 2013. The disclosures of these three United States Patent Application Publications are incorporated by reference. Any one of these systems can be utilized to locate the user's smart phone, and thereby locate the user with good accuracy indoors. The information concerning the user's location derived by the use of any of these methods can be taken into account by the smart phone application to provide the user with a recommended exit route.

In this case, the data transmitted by the wireless local area network transmitter includes the locations of the several fire exits in the building. This information, together with the information on the user's location enables the system to provide a recommended exit route.

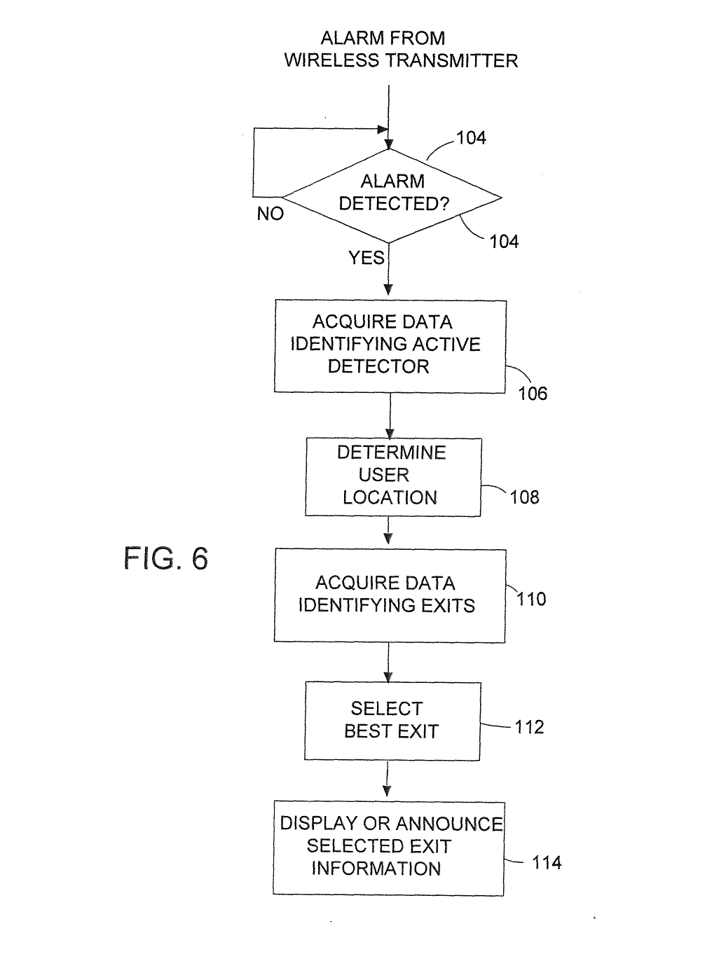

FIG. 6 shows the essential steps carried out by the smart phone application when used to determine an optimum exit rout from several possible choices.

When a smart phone receives an alarm signal from a wireless transmitter unit associated with a smoke detector the smart phone application validates the alarm signal at step 104. If a valid alarm signal is detected, the application then acquires data within the alarm signal identifying the active detector in step 106. At step 108, the application also acquires data concerning the smart phone user's location within the building, using a local indoor location system, for example one of the several systems mentioned above. In step 110, the application also acquires data transmitted in the wireless alarm signal concerning the available exits in the building. The transmitted data concerning available exits will ordinarily include information concerning all the exits on all floors of the building. However, the application, having determined the user's location, including the floor of the building on which the user is located, then utilizes only the exits on that floor as potential escape route choices, and, at step 112, selects the appropriate exit by taking into account the location of the active detector and the location of the smart phone as determined by the local indoor location system.

The determination of the appropriate exit can be based on any of a number of possible algorithms. In general, the selected exit will be the exit farthest from the active detector provided that the path from the user's present location does not require the user to pass into close proximity to the active detector. If, for example, the active detector is on the floor currently occupied by the user, the algorithm should direct the user to follow a route away from the active detector toward the nearest exit along that route.

At step 114, the exit information is displayed on the smart phone's display screen and can be simultaneously announced audibly if the smart phone application is programmed to activate the smart phone's hands-free speaker capability and generate a pre-recorded or synthesized announcement based on the data received from the wireless transmitter.

Where the user's location is used to select an exit route automatically, the smart phone application can be individualized for each building to which it applies. A typical message displayed or played audibly to the user whose recommended exit path is stairwell B would be: “FIRE ON FLOOR FIVE, PLEASE EXIT USING STAIRWELL B.” Where the smart phone application is a dedicated application for use with a particular building, it can also be programmed to cause the smart phone screen to display a map that shows both the user's present location and the location of the recommended exit.

Various modifications can be made to the alarm system and additional features can be incorporated into the wireless transmitter unit or the smart phone application. For example, in the version of the system shown in FIGS. 1-3, in which the smoke detector communicates acoustically with the transmitter unit. The alarm signal is transmitted only when the duration of the smoke detector sound exceeds a predetermined short interval exceeding the interval of the low battery warning. However, the wireless transmitter unit can generate a low battery warning that identifies the detector in which the battery or batteries should be replaced, and send the warning as a message to users' smart phones without generating an emergency alarm. Another optional feature is the generation of an emergency message that is transmitted to a user's smart phone over a cellular network so that the user can be alerted to a hazardous condition even when away from home. Such an emergency message can be transmitted if the wireless transmitter is a wireless access point, or is associated with a wireless access point, or alternatively, if the wireless transmitter unit include or is associated with a cellular telephone.

What is claimed is:

1. An alarm system comprising:
a detector for producing an electrical signal in response to a hazardous condition;
a wireless local area network transmitter responsive to said electrical signal for producing a radio signal indicative of said hazardous condition;
a smart phone having a wireless receiver capable of receiving said radio signal and having a smart phone application stored therein, which, when activated, causes said smart phone to generate an alarm in response to said radio signal.

2. An alarm system according to claim 1, in which said wireless local area network transmitter is a part of a wireless access point.

3. An alarm system according to claim 1, in which said smart phone application includes means for automatically turning on said wireless receiver in the smart phone when said smart phone application is activated.

4. An alarm system according to claim 1, in which said alarm includes both visual and audible elements.

5. An alarm system according to claim 1, in which the wireless local area network transmitter includes means for transmitting data the location of said detector in said radio signal indicative of said hazardous condition.

6. An alarm system according to claim 5, in which said smart phone application includes means responsive to said data for displaying the information indicating the location of said detector.

7. An alarm system according to claim 1, in which the wireless local area network transmitter includes means for transmitting data indicating the location of said transmitter in said radio signal indicative of said hazardous condition.

8. An alarm system according to claim 7, in which said smart phone application includes means responsive to said data for displaying information indicating the location of said transmitter.

9. An alarm system according to claim 1, in which the wireless local area network transmitter includes means for transmitting data in said radio signal indicative of said hazardous condition, said data the location of said detector and also the location of at least one fire exit through which a user of said smart phone can escape without passing into dangerous proximity to said detector.

10. An alarm system according to claim 1, in which the wireless local area network transmitter includes means for transmitting data in said radio signal indicative of said hazardous condition, said data the location of at least one fire exit through which a user of said smart phone can escape without passing into dangerous proximity to said detector, and in which said smart phone application includes means responsive to said data for displaying information the location of said at least one fire exit.

11. An alarm system according to claim 1, in which the detector includes a smoke detector, a transducer responsive to the smoke detector for emitting an audible sound at a predetermined frequency, a microphone producing an output, a frequency-selective filter connected to the output of the microphone for passing microphone output at said predetermined frequency while attenuating microphone output at frequencies other than said predetermined frequency, said electrical signal being derived from the microphone output passed by said filter.

12. An alarm system according to claim 11, in which the transmitter includes a timer and means responsive to said timer and to said microphone output passed by said frequency-selective filter for causing said wireless local area network transmitter to produce said radio signal indicative of said hazardous condition only when the duration of the microphone output passed by said frequency-selective filter in response to said audible sound exceeds a predetermined limit.

13. An alarm system according to claim 1, in which the wireless local area network transmitter includes means for transmitting data in said radio signal indicative of said hazardous condition, said data the location of at least one fire exit through which a user of said smart phone can escape without passing into dangerous proximity to said detector, and in which said smart phone application includes means responsive to said data for displaying a an escape route to said at least one fire exit.

14. An alarm system according to claim 1, in which the wireless local area network transmitter includes means for transmitting data in said radio signal indicative of said hazardous condition, said data the locations of plural fire exits, and in which said smart phone application includes means for determining the position of the smart phone in relation to the detector, and means responsive to said position-determining means for selecting one of said fire exits, through which the user of the smart phone can escape without passing into dangerous proximity to said detector and for displaying an escape route from the present location of the smart phone to the selected fire exit.
